(19) United States
(12) Patent Application Publication
(10) Pub. No.: US 2019/0153689 A1
(43) Pub. Date: May 23, 2019

(54) Wave Power Plant

(71) Applicant: Harald Ørjavik, Vevang (NO)

(72) Inventor: Harald Ørjavik, Vevang (NO)

(21) Appl. No.: 16/164,982

(22) Filed: Oct. 19, 2018

Related U.S. Application Data
(63) Continuation of application No. 15/318,982, filed on Dec. 15, 2016, now abandoned.

(30) Foreign Application Priority Data
Jun. 17, 2014 (NO) 20140762
Jun. 15, 2015 (NO) 20150775
Jun. 15, 2015 (NO) PCT/NO2015/000013

(51) Int. Cl. E02B 9/08; F03B 13/26; F03B 13/22; F03B 13/14

(52) U.S. Cl. CPC E02B 9/08; F03B 13/268; Y02E 10/38; F03B 13/145; Y02E 10/28; F03B 13/22

(57) ABSTRACT

Wave-power plant where the waves are guiding water into a basin, and where power is produced when water flows back into the sea through a turbine. The basin exhibits a bottom (4) positioned at least several typical wave heights down into the water, a rear wall (3), two side walls (2), a front wall (1) fronting the waves, and for larger plants, at least one partition wall (5) dividing the basins into several smaller basins. The front wall (1) and one or more division walls (5) are covered by apertures provided with check-valves (6) to allow through flow toward rear basin (14) providing water to at least one turbine (8). The basin can rest with its bottom (4) directly upon the seabed (13), and in deeper waters, above the seabed with the bottom (4) of the basin also being covered by apertures exhibiting check valves (6) for flow into the basin.

### CROSS-REFERENCE TO RELATED APPLICATIONS

This application is a continuation of U.S. patent application Ser. No. 15/318,982, filed Dec. 15, 2016, which claims priority on International PCT Application No. PCT/N02015/000013, filed Jun. 15, 2015, which claims priority on Norwegian Patent Application Nos. 20140762, filed Jun. 17, 2014, and 20150775, filed Jun. 15, 2015, each of which is incorporated herein by reference in its entirety.

### TECHNICAL FIELD

The present invention is directed to wave power plants which employ turbines.

### BACKGROUND

Wave power plants typically include openings with check valves near the sea level on a side of the basin which is turned against the waves. When a wave moves rapidly, the water particles move only locally, slowly and very little compared to the wave's length. The water must use most of its energy in order to enter the basin. Because the water has to move a rather long distance compared to the height of the crest of the wave, to the level in the basin which is of short duration when the wave is at a level before the basin, there will be very little water which has sufficient time to stream into the basin. A small wave which follows a large wave will often lack the height to move water into the basin.

### SUMMARY OF THE INVENTION

The present invention avoids the uneven power of devices (also known as plants, “devices” and “plants” as well as their singular form used interchangeably herein) based on floating bodies, bottom hinged plates or walls and water columns, in which the waves move, where it is extremely difficult to guide these movements in relation to the waves, in order to allow devices can be effective. It is difficult to make these devices large enough to fit that the wave power is scattered over large areas.

With wave power plants according to the invention, the waves transmit their energy efficiently into the basin, as both big and small waves, and accommodates the tides. In the basin, the kinetic energy is also transformed into potential energy for utilization in the turbine. The plants (devices) are suited for large capacities, and can provide for smooth power production. With large waves, the power output and the loads are reduced, so that the plant can produce power from large waves. The plants are also suited for mounting in deep water, for example, in wave power parks.

According to the invention, the basin is positionable to accommodate various wave heights in the water. The plant of the invention includes, a back wall, two side walls, a front wall positioned against the waves, and one or more division walls, which divide the basin into smaller basins (e.g., sub basins). The front wall and the division walls are covered with openings with check valves for throughput in the wave direction against the rear (back) basin, through which water is fed into at least one turbine. The basin is of a sufficient depth, and the check valves openings sufficiently sized, so that the waves flow directly into the basin according to their natural flow, with comparatively slow motion of the water particles, resulting in small energy losses until the waves are stopped by the back wall.

The check valves in the walls lock the waves at their crest and prevent waves in the basins from disturbing the turbine and losing energy. At least one turbine receives water from the back basin and water from the basins before passing through the openings with check valves in the division walls. This passage of the water is gradual, as the water level in the back basin remains under the levels in the forward or previous basins. When the waves press the water surface up, and are stopped in their kinetic energy, which makes up 50% of the wave energy, the wave energy is transformed into potential energy, which is be used in the turbine. When the sea level is not too deep, the plant can stand directly on the sea floor. At deeper water levels, the plant can be placed above the sea floor and have the bottom also covered with openings with check valves. The plant can be placed on a construction or mounted on a floating structure.

The plant of the invention works with waves near to the shore, where the wave direction are stable. Further from the shore, where the wave direction can change significantly, the plant must be turned against the waves. Tidal variations of the sea level can be managed by making the walls of sufficient height for accommodating high tide. In order to guide waves which are moving diagonally against the plant, the plant is mounted, such that one or more closed walls from the front wall allow for water movement through at least one basin. With large plants with the basin placed above the sea floor, the closed walls can extend from the front wall to the rear basin, so that the valves in the bottom wall can be kept open for unloading the plant with water, which flowed over the basin with the large waves. Water which is brought into the other basins when the valves in the bottom wall are closed will normally flow into the back basin and further into the turbine, so that the plant can operate with large waves. The check valves in the bottom wall can be kept open by means of floats when the basin is overfilled and locked in a certain order, so that blockages can be avoided. The walls include openings with check valves, and accordingly, are protected against large waves. The plants are protected by keeping the valves open. In order to protect the back wall against large waves, especially with fixed mounted plants, the plant can be equipped with hatches in rows over each other, which can open and close as is necessary. Since the hatches are placed in rows at different heights, they can also be used to regulate the maximum wave heights in the basin, as caused by tides.

The length of the basin is adapted to the length of the typical waves which are to be harvested.

By using short basins placed above the sea floor, the back wall of the plant can be extended beneath the basin in order to increase the power output and to protect the outlet of the turbine against the waves.

In order to obtain a smooth power output, the plant can employ a larger basin by making it longer. The large depth of the basin provides good conditions for the streaming of water into the turbine. For large plants, the division walls include openings with check valves in the back basin on each side of the turbine or turbines so that they cannot be disturbed by waves in the back basin. Standing waves in the back basin can also be prevented by cross walls, which are low enough, such that the water can stream over the walls and further into the turbines.

This can be achieved by using closed walls from the front wall to the back basin, which is extended along the back wall at approximately half height. To prevent debris in the sea from entering the plant, a net or netting can be positioned before the front wall, and alternatively, beneath the basin, with plants above the sea floor. When waves are caused by storms, they can go over the basin, such that it can be covered with netting or grates. In order to ease the mounting and management of the check valves, the check valves can be mounted in frames with multiple openings with check valves. The frames can be mounted from the top of the walls by pushing them between walls, from the top to the bottom. In deeper water the plants can be mounted with floats under the water with taunt anchor cables which keep the device floating at the proper height. Special anchor cables can turn the plant against the waves. Alternatively the plant can be turned against the waves by at least one horizontal wing with the axis pointing to the center of the plant, which changes the operating angle when the water level rises and falls with the waves. The plant can be turned in the opposite direction by turning the wing 180 degrees about its axis, or by moving the axis in the wing. The outlet from the turbine can be protected against the waves by allowing water to flow out behind the device. The outlet is more efficient if water flows to a basin or chamber, which drains through great areas covered with openings with check valves, and which has cross walls covered with openings with check valves, for streaming water away from the turbine. With fixed plants they can be emptied of water, so as to produce power by smaller waves. With floating plants, which have stabilizing plates submerged in the depth, the turbine's water output goes to chambers placed on the sides and behind the plant, between robust floats at the corners of the plant. The plant may be rotatably mounted on a tower.

### BRIEF DESCRIPTION OF THE DRAWINGS

The invention is explained in detail with reference to embodiments as shown in the attached drawings.

FIG. 1 is a plan view of a plant in accordance with embodiments of the present invention for placement on the sea floor.

FIG. 2 is a cross sectional view of the plant of FIG. 1 located on the sea floor.

FIGS. 3 and 4 show a sectional view of the plant of FIG. 1.

FIGS. 5 and 6 show plan and cut views of the plant of FIG. 1 mounted above the sea floor.

FIGS. 7 and 8 show plan and cut views of a floating plant in accordance with embodiments of the present invention.

FIGS. 9 and 10 show plan and cut views of a floating plant with anchor cables joined together.

FIG.11 is a sectional view of a valve. FIG. 12 shows a cut through view of an open valve.

FIG. 13 shows a plan view of the valve.

FIG. 14 shows valves mounted on a through shaft.

### DETAILED DESCRIPTION OF THE INVENTION

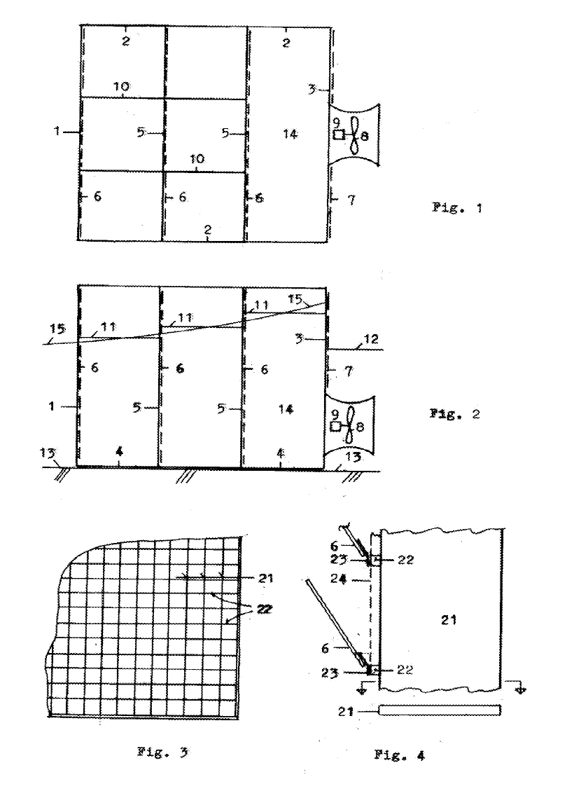

FIG. 1 shows a plan view and FIG. 2 shows a cross sectional view in which the wave direction is towards a plant, which is configured in some embodiments to rest on the sea floor. The basin is of a depth such that the waves can enter directly into the basin in their natural flow through the front section (1), which is covered with check valves (6). The wave moves further through the partitions or wails (5), which are covered with openings with check valves (6) therein, until the waves are stopped by the rear wall (3). The check valves lock the water inside the rear basin (14) when the water level (15) reaches its highest level.

The fall height is exploited by the turbine (8), which receives water from the rear basin (14) with the water at the highest height arriving first, and afterwards from the front basins when the water level in the rear basin (14) reduces to a level that is lower than the water level in the front basins. Optionally, inner walls (10) can be placed from the front (1) through at least one basin, e.g., the front basin, in order to guide diagonally oriented waves into the rear basin.

When successive waves enter the plant, it is favorable that even if the waves have variable heights, periods and direction may influence each other. However, the waves remain independent of each other so that they can cross one another without influencing the movement of one another. The higher the water level (11) is in the plant, the less water the waves bring into the basin in order for their energy to be converted. An operator can choose to a certain extent whether the turbine (8) operates with less water and greater fall height or more water and less fall height by choosing the drainage rate of the basin. If a small wave follows a big wave, and the small wave lacks the power needed in order to lift the water level in the rear basin, it can convert its energy in the front basins where the water level is lower after the passage of a big wave. The walls which have openings with check valves are protected from big waves. The rear wall (3) may have hatches (7) in row at different heights, which can open and close in order to adjust the height of the rear wall (3) during tidal variation in sea level. The outlet from the turbine is placed behind the rear wall (3) in order to protect it from wave disturbances. Further protection can be achieved by extending the side walls (2) behind the plant or with broadening the plant. The plant can operate to cover variable power demands to produce maximum amounts of power.

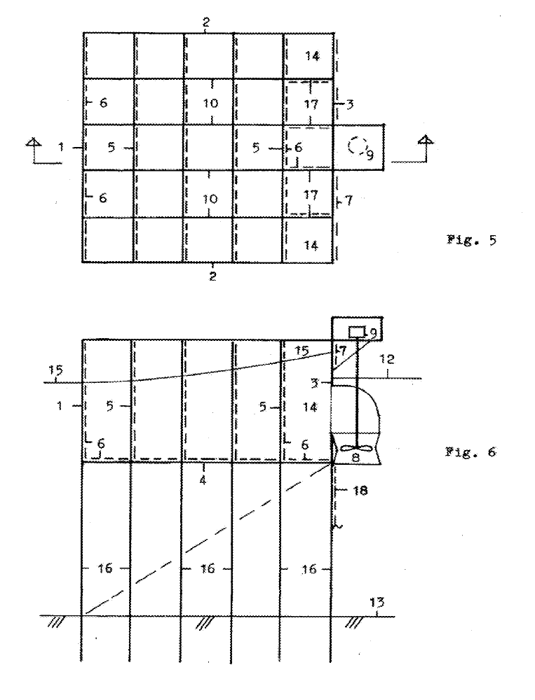

FIG. 3 shows a section with openings for check valves and FIG. 4 shows an opening with a check valve (6) which is hinged on one side so that the opening is free by the open valve. The valves open easily and close quickly with small spring forces. The valves are made with a relatively small distance between the hinge side and the opposite side. In order for the sections with openings to get a large flow area, the bearing profiles (21) are thin and wide. In vertical walls (1 and 5) the profiles (21) can be vertical. The profiles (21) in the front wall (1) will contribute, due to their width, to guide the diagonally oriented waves into the plant. When the water enters into the basin, the valves are typically hinged. If they are side hinged, the valve movement will not be disturbed by the weight or variable weights of the valves, which have a rather small spring force. At the bottom of the basin, the bearing profiles (21) in the frames are oriented in the wave direction and the valves (6) are hinged in the front edge. The valves (6) can be hinged with flat rubber (23) in order to be more robust against debris in the water.

Components (24) are short profiles between the profiles (22) below the ends of two valves (6) and are preferably located on the edge to the bearing profiles (21). The sections may be made of wood, plastic, aluminum or other materials.

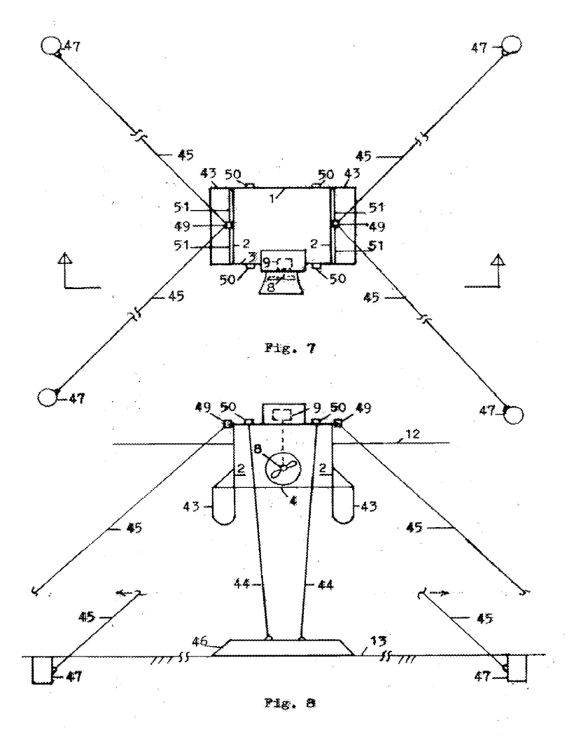

FIG. 5 shows a plan view and FIG. 6 shows a cross-sectional view of a plant placed in deeper water above the sea floor (13) on stakes (16) and which its bottom is covered with openings with check valves (6). The plant basin has some lengthening (18) in its rear wall (3) beneath the basin. The inside of the basin needs to be deeper than the basin's casing so that waves which enter into the front part of the basin can go further to the rear wall (3) of the basin. The inner closed walls (10) divide the basin between the front wall (1) and the forward wall (5) of the rear basin (14) into several spaces. In the rear basin (14), the walls (17) between the forward wall (5) and the rear wall (3) divide the basin (14) in several spaces. The walls 17 are covered with apertures having check valves for flow to the turbine. In cases where large plants and big waves are involved there is a possibility of too much water entering the plant and possibly above the plant. In these cases, the bottom valves (6) are kept open in one or more spaces formed by the walls (10) in order to unload the construction. Where the bottom valves (6) are open, water from above can flow down through the open valves and maintain the pressure underneath the plant so that the bottom in spaces with sealed valves are unloaded. In those spaces where the valves are closed at the bottom the water will flow to the rear basin (14) and further to the turbine (8) so that the plant can be operated by large waves.

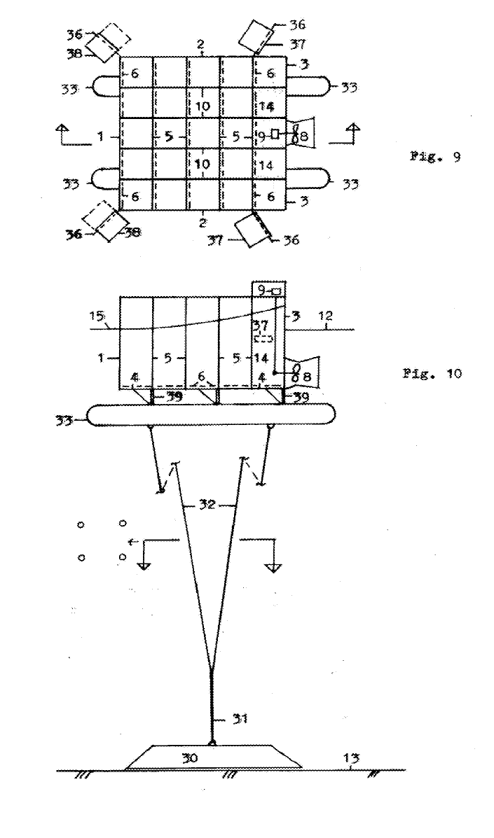

FIGS. 7 and 8 show a plan view and a cross-sectional view of a wave power plant with floats (43) underneath and attached to the side walls (2), so that the plant can be towed easily to the mounting place and mounted while floating with taunt anchor cables (44) from an anchor (46) to the anchor fastening (50). The anchor fastening (50) is located on the wave power plant which may be equipped with winches. When mounting, the anchor cables (44) are tightened so that the floats (43) extend deep in the water, so that the buoyancy is not too much disturbed by the waves. The buoyancy of the floats can be adjusted with ballast water. The anchor cables (44) can be used to adjust the height of the plant at large tide differences. In order to turn the plant against the waves it is equipped with one rail (51) on each opposite side of the plant with fastenings (49) for anchor cables which can move opposite on the rails. Each of the fastening (49) are kept in place by two anchor cables (45) which extend to their own anchor (47) so that a large angle between the anchor cables (45) is created. If there are large tide differences, the height of the plant must be adjusted. The anchor cables (45) extend via buoys thus extending more horizontally towards the wave power plant. In cases where the wave power plant must be turned more than 90 degrees, the rails (51) are circular or otherwise rounded and longer.

FIGS. 9 and 10 show a plan view and a cut-out view of a wave power plant floating in deep water which can be turned towards the waves. The side walls (2) and the walls (10) are formed to be beams that carry the plant. They rest on three beams (39) crosswise of the plant, which rests on two long floating bodies (33) oriented to be in the wave direction and placed under the plant with certain distance between them. Since the water movement decreases exponentially in depth, the floating bodies (33) are disturbed minimally by the waves.

If there are strong currents, the floats can be turned 90 degrees, so that the side walls (2) and the walls (10) rest more directly on the floats (33). Each float (33) has at least two taunt anchor cables with one facing each end in order to keep it under the water surface (12). The anchor cables (32) merge together to one anchor cable (31) at a certain distance above the anchor so that the plant can be turned towards the waves easily. In situations where a horizontal force pushes the plant away from the anchor (30), a force from the anchor cables (31 and 32) with a horizontal component will keep the plant in place. The plant is turned towards the waves using a wing (37) on each side of the plant, which can rotate on an axle that is oriented toward the center of the plant. When the water of the waves moves up and down the wing (37), the wing (37) is given an alternative angle, to produce a horizontal force. The forces of the two wings (37) work against each other and equalize each other when the waves are straight on the plant. When the waves move in a slope formation to the plant, one of the wings (37) leaks in order to loose force, while the other gets more force as the wave's height increases when the waves hit the side (2) of the plant. If the plant is to turn accurately towards the waves, one or more wings (38) can be used and placed in the front towards the waves and work together with guidance from sensors for wave direction. When the plant needs to be turned the opposite direction, the wings are turned around 180 degrees about the shaft. Alternately, the plant can be turned against the waves using an electric motor with a propeller.

Since the plant is not rigidly mounted, the loads from the large waves become smaller. Because the bottom (4) of the plant is covered with check valves (6), the loads in the anchor cables (31 and 32) by the large waves are limited to the buoyancy of the floating bodies (33). If an extraordinarily large or rogue wave reaches the plant, and the anchor cables (31 and 32) increase in slack, there will be a limited pulling force when the cables return to their taunt state, because the bottom (4) is covered with check valves (6). The loads are relatively small because at the instant that the anchor cables (31 and 32) become taunt, the water level (12) has not yet returned to the height that causes the lift of the floats (33) have started to load the anchor cables (31 and 32). The large floats (33) keep the plant above the water for easier transport and servicing. The anchor cables (31 and 32) can be mounted while they have slack by lowering the plant into the water by the floats (33). The floats (33) are filled with enough water to keep the plant floating by means of smaller floats at the top of the plant. A control cable attaches to the anchor, such that the guide wire extends to the surface, allowing the fastening cable (31) to be sunk, lowered and locked to the anchor without the use of divers. By adapting the length of the anchor cables (32) the plant can be mounted in a slope formation, if there is a need to get more height at the rear basin (14). The floats (33) can be supplemented or replaced with floats that are built into the lower parts of the side walls (2) and the inner walls (10).

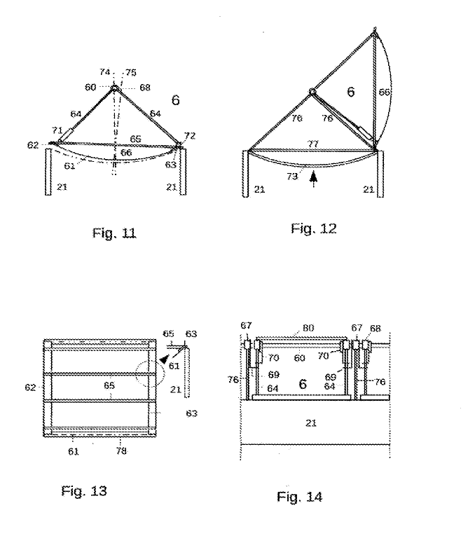

FIGS. 11-14 show one check valve (6) which opens and closes rapidly so that it can be used in larger plants with fewer valves.

FIG. 11 is a sectional view of the valve (6) having a curved plate (61) with two straight edges fixed to two opposite edge profiles (62) and (63) on a flat frame with transverse grooves (65) and transverse walls, in order to stiffen the curved plate (61). The valve body is attached to the axles (60) at rods (64). When the valve opens and closes, the curved valve plate (61) moves in or near a circle of the same radius. The valves are spring mounted to the rods (64) at the edge profile (62) of the spring system (71) and, alternatively at the edge profile (63) of the spring system (72) so that the valve stops with slight clearance to the valve seat when it closes and rests against the seat, in response to increased pressure. If the valve stops with clearance on both sides, at the edge profile (62), this means that the curved valve plate (61) stands in a slightly sloped formation in a circular path with the center in the axle so that the water can assist in both openings and closings of the valve. The spring system (71) at the edge profile (62) is typically compressed by the water pressure so that the valve moves into a loped formation relative to a circle track with the center in the axle (60), so that it can open easily. The curved valve plate (61) can then be in a circle and move in along circle track with its center in the axle.

FIG. 12 shows a cut-out view of an open valve. The curved profile (73) is valve seat for the curved ends of the valve. The rods (77) maintain the appropriate predetermined distance between the profiles (21), and the edge are seats seated. The rods (76) carry the hearing housing (67) to the axle (60) (FIG. 14).

FIG. 13 shows a plan view of the valve with an extension (78) of rubber on the inside of the curved valve plate (61) which rests against the curved valve seat (73) in order to simplify production and enhance securement and tightness.

FIG. 14 shows valves mounted on through shaft (60). A spring system (69) provides a closing force to the valve with a rod (64) supporting the valve so that it can close quickly when the water stops flowing. The spring system (70) is stressed in advance, and fixed on the axle (60) with a rod to the valve rods (64), in order to open the valve and to keep it in an open position by turning the axle to the position for the open valve. The spring system (70) prevents damage when the valve accumulates sufficient pressure, such that it cannot be opened before it is unloaded. A brace (80) locks at least two rods (64) at each end of the valve to each other, so that they rotate together around the axle (60). If the axle (60) is not used to keep the valve open, the rods (64) can be fixedly mounted on the axle (60) and the rod (80) can be left out. Each valve has its own axle (60).

1.-19. (canceled)

20. A wave-power plant for generating power from the waves of a body of water having a seabed or floor, the wave power plant comprising: a basin resting directly on the seabed or floor, the basin having a bottom (4) positioned a distance below the water level of the body of water at a selected depth, a rear wall (3), two side walls (2), a front wall (1) facing the waves of the body of water, and at least one partition wall (5) dividing the basin into two or more smaller basins, said front wall (1) and the partition walls (5) being covered by apertures provided with check-valves (6) to allow water flow through said walls through the apertures having check valves, the basin having a depth sufficient for the waves to move through the front wall (1) and the at least one partition wall (5) and guide water toward a rear basin (14) to at least one turbine (8) for producing power as water flows through the at least one turbine, an outlet of the at least one turbine being directed to at least one outlet basin in order to be protected from disturbances from wave crests, the at least one outlet basin having at least one partition wall covered with apertures having check valves to allow water to flow away from the turbine, the at least one outlet basin having an area configured to allow the same amount of water flow that flows through the turbine, the at least one outlet basin having at least one outer wall covered with apertures having check valves for the water to flow out to the body of water.

21. A wave-power plant for generating power from the waves of a deep body of water having a seabed or floor, the wave power plant comprising: a basin having a bottom (4) positioned a distance below the water level of the body of water at a selected depth, a rear wall (3), two side walls (2), a front wall (1) facing the most common direction of waves of the body of water, and at least one partition wall (5) dividing the basin into two or more smaller basins, said bottom wall (4) and the at least one partition wall (5) being covered by apertures provided with check-valves (6) to allow water flow through the bottom wall (4) into the basin and through the at least one partition wall (5) through the apertures having check valves, the basin having a depth sufficient for the water to flow with little loss through the-at least one partition wall (5) toward a basin (14) supplying water to at least one turbine (8) for producing power as water flows through the at least one turbine, an outlet of the at least one turbine being directed to at least one outlet basin in order to be protected from disturbances from wave crests, the at least one outlet basin having at least one partition wall covered with apertures having check valves to allow water to flow away from the turbine, the at least one outlet basin having an area configured to allow the same amount of water flow that flows through the turbine, the at least one outlet basin having at least one bottom wall covered with apertures having check valves for the water to flow out to the body of water.

22. The wave power plant of claim 21, wherein the front wall (1) is covered with apertures having check valves for the waves to guide water into the basin wherein the plant is turned against the waves.

23. The wave power plant of claim 21, wherein part of the at least one outlet basin has a top wall.

24. The wave power plant of claim 21, wherein the plant accommodates big waves by means of open valves in the at least one bottom wall.

25. The wave-power plant of claim 21, wherein the plant is assembled floating in deep water at a determined height and has at least one submerged buoyancy tank and at least 3 tight anchor lines extending from 3 attachments on the plant that are secured to at least one anchor on the seabed or floor located below the plant.

26. The wave-power plant of claim 21 wherein the plant has at least two buoyancy tanks (33) positioned below the plant, each being spaced apart a selected a distance, wherein at least two tight anchor lines (32) extend from each tank (33) that are attached at or near the end of the tanks (33), the at least two anchor lines converging toward each other forming one anchor line (31) that extends a distance above and is attached to an anchor (30) located on the seabed or floor attachment to allow the plant to be pivoted so that the plant can be to be turned against the waves.

27. The wave-power plant of claim 21, wherein the plant has at least one wing (38) configured as a frame with apertures having check valves as used in the walls on the plant, positioned outside the plant down into the water which the waves are moving, the wing is mounted to have an adjustable angle relative to the horizontal plane for force in one direction or opposite direction in order to turn the plant against the waves.

28. The wave power plant of claim 21, wherein the plant has at least one electric motor with a propeller which can rotate in opposite directions, and is positioned in the water outside the plant in order to turn the plant against the waves.
